(19) United States
(12) Patent Application Publication
(10) Pub. No.: US 2026/0308407 A1
(43) Pub. Date: Oct. 8, 2026

(54) INKJET INK

(71) Applicant: KYOCERA DOCUMENT SOLUTIONS INC., OSAKA (JP)

(72) Inventor: NORIAKI OZAWA, OSAKA (JP)

(21) Appl. No.: 19/571,532

(22) Filed: Mar. 19, 2026

(30) Foreign Application Priority Data
Apr. 4, 2025 (JP) 2025-062522

(51) Int. Cl. C09D 11/38

(52) U.S. Cl. CPC C09D 11/38

(57) ABSTRACT

An inkjet ink includes: a pigment, a pigment dispersion resin, a water-soluble moisturizing agent, and water. The pigment dispersion resin is formed of a block copolymer that includes a hydrophilic polymer block X formed of methacrylic acid and a hydrophobic polymer block Y formed of benzylmethacrylate and has a block sequence of X-Y-X and an acid value of 60 mg KOH/g or more and 120 mg KOH/g or less. The water-soluble moisturizing agent includes at least one of a polyhydric alcohol monoisopropyl ether or a polyhydric alcohol monobutyl ether.

### CROSS-REFERENCE TO RELATED PATENT APPLICATION

This application claims the benefit of Japanese Priority Patent Application JP 2025-062522 on Apr. 4, 2025, the entire contents of which are incorporated herein by reference.

### FIELD OF THE DISCLOSURE

The present disclosure relates to an inkjet ink.

### BACKGROUND OF THE DISCLOSURE

Inkjet inks are desired to have high image density for recording clear images with high visibility on recording media. Meanwhile, the inkjet inks are desired to be capable of forming high-quality images on recording media without gaps.

### SUMMARY OF THE DISCLOSURE

An inkjet ink according to an embodiment of the present disclosure includes: a pigment; a pigment dispersion resin; a water-soluble moisturizing agent; and water.

The pigment dispersion resin is formed of a block copolymer that includes a hydrophilic polymer block X formed of methacrylic acid and a hydrophobic polymer block Y formed of benzylmethacrylate and has a block sequence of X-Y-X and an acid value of 60 mg KOH/g or more and 120 mg KOH/g or less.

The water-soluble moisturizing agent includes at least one of a polyhydric alcohol monoisopropyl ether or a polyhydric alcohol monobutyl ether.

### DETAILED DESCRIPTION OF THE EXEMPLARY EMBODIMENTS

In inkjet inks, it is favorable that pigments are agglomerated on a recording medium for improving the image density of an image to be recorded on the recording medium. Meanwhile, the inkjet inks need to ensure diffusiveness of pigments on the recording medium for forming high-quality images on the recording medium without gaps. That is, in the inkjet inks, opposing behavior of agglomeration and diffusion of pigments is desired after impact on the recording medium.

In view of the circumstances as described above, it is an object of the present disclosure to provide an inkjet ink capable of achieving both image density and diffusiveness of pigments.

An embodiment of the present disclosure will be described.

### [Configuration of Ink]

### (Schematic Configuration)

An inkjet ink according to an embodiment of the present disclosure (hereinafter, also referred to simply as an “ink”) includes a pigment a, a pigment dispersion resin b, a water-soluble moisturizing agent c, and water. The ink according to this embodiment is a water-based ink that is ejected from a recording head of an inkjet recording apparatus onto a recording medium to record an image on the recording medium. The recording medium on which an image is to be recorded by the ink according to this embodiment is formed of a hydrophilic fiber such as a cellulose fiber. Examples of such a recording medium include plain paper, copy paper, recycled paper, thin paper, and thick paper.

The ink according to this embodiment exhibits characteristic behavior that the pigment a agglomerates during the stage of moisture evaporation after impact on the recording medium and the pigment a diffuses during the stage of penetration into the recording medium, by using the pigment dispersion resin b having a specific configuration and the water-soluble moisturizing agent c having a specific configuration in combination. As a result, the ink according to this embodiment is capable of achieving both image density and diffusiveness of the pigment a. Details of each component of the ink according to this embodiment will be described below.

### (Pigment a)

The ink according to this embodiment includes the pigment a as a coloring agent from the viewpoints of color mixing prevention and improvement in water resistance in images recorded on the recording medium. The pigment a may be either an inorganic pigment or an organic pigment. Further, as the pigment a, these may be combined with an extender pigment as necessary.

Specific examples of the inorganic pigment that can be used in the ink according to this embodiment include carbon black and a metal oxide. In particular, in the case of a black ink, carbon black is favorable. Examples of the carbon black include furnace black, thermal lamp black, acetylene black, and channel black.

Specific examples of the organic pigment that can be used in the ink according to this embodiment include an azo pigment, a diazo pigment, a phthalocyanine pigment, a quinacridone pigment, an isoindolinone pigment, a dioxazine pigment, a perylene pigment, a perinone pigment, a thioindigo pigment, an anthraquinone pigment, and a quinophthalone pigment.

In the ink according to this embodiment, the hue is not particularly limited, and a colored pigment of any of colors such as yellow, magenta, cyan, blue, red, orange, and green can be used. Favorable specific examples of the colored pigment include C.I. Pigment Yellow, C.I. Pigment Red, C.I. Pigment Orange, C.I. Pigment Violet, C.I. Pigment Blue, and C.I. Pigment Green. The ink according to this embodiment can use one or two or more selected from these colored pigments as the pigment a.

### (Pigment Dispersion Resin b)

In the ink according to this embodiment, the pigment dispersion resin b is blended as a dispersant that is adsorbed on the surface of the pigment a to enhance the dispersibility of the pigment a in the solvent. In the ink according to this embodiment, fine particles of a benzylmethacrylate/methacrylic acid copolymer are used as the pigment dispersion resin b. In more detail, the pigment dispersion resin b is a block copolymer that includes a hydrophilic polymer block X formed of methacrylic acid and a hydrophobic polymer block Y formed of benzylmethacrylate and has a block sequence of X-Y-X. Further, the pigment dispersion resin b has an acid value of 60 mg KOH/g or more and 120 mg KOH/g or less. In the pigment dispersion resin b, methacrylic acid that is the hydrophilic polymer block X has the effect of improving permeability into the recording medium and benzylmethacrylate that is the hydrophobic polymer block Y has the effect of improving image density.

In the ink according to this embodiment, in order to sufficiently achieve the above effect of the pigment dispersion resin b, the content of the pigment dispersion resin b is favorably 0.5 mass % or more. Further, in the ink according to this embodiment, in order to achieve high dispersion stability, the content of the pigment dispersion resin b is 7.0 mass % or less.

### (Water-Soluble Moisturizing Agent c)

In the ink according to this embodiment, the hydrophobic water-soluble moisturizing agent c is blended. The ink according to this embodiment includes at least one of a polyhydric alcohol monoisopropyl ether or a polyhydric alcohol monobutyl ether as the water-soluble moisturizing agent c. In the ink according to this embodiment, the action of reducing surface tension by the hydrophobic water-soluble moisturizing agent c allows the pigment dispersion that is a complex of the pigment a and the pigment dispersion resin b adsorbed thereon to diffuse in in the recording medium while maintaining the image density.

In the ink according to this embodiment, in order to sufficiently achieve the above effect of the water-soluble moisturizing agent c, the content of the water-soluble moisturizing agent c is favorably 0.3 mass % or more. Further, in the ink according to this embodiment, in order to achieve high dispersion stability, the content of the water-soluble moisturizing agent c is favorably 7.0 mass % or less.

### (Water)

In the ink according to this embodiment, ion exchanged water, purified water, distilled water, or the like can be used as water. In the ink according to this embodiment, the content of water is favorably 40 mass % or more and 60 mass % or less from the viewpoints of dryness and ejection reliability.

### (Other Components)

In the ink according to this embodiment, components other than the above may be blended as necessary. For example, in the ink according to this embodiment, a surfactant may be blended. The surfactant has the effect of enhancing the wettability of the ink on a recording medium and the effect of enhancing the compatibility and dispersion stability of each component included in the ink. Examples of the surfactant blended in the ink according to this embodiment include an anionic surfactant, a cationic surfactant, a non-ionic surfactant, and an amphoteric surfactant. The surfactant is favorably a non-ionic surfactant. The non-ionic surfactant is favorably a surfactant having an acetylene bond, more favorably a surfactant having an acetylene glycol structure or an acetylene alcohol structure.

Further, in the ink according to this embodiment, various additives such as a penetrating agent, a dissolution stabilizer, an anti-drying agent, an antioxidant, a viscosity adjustor, a pH adjuster, a neutralizer, and an antifungal agent may be blended as necessary in addition to the surfactant.

### EXAMPLE

Inks were prepared and evaluated as Examples 1 to 3 of the present disclosure. The content common to Examples 1 to 3 will be described below, and then the individual content of each of Examples 1 to 3 will be described.

### (Preparation of Ink)

In Examples 1 to 3, first, a pigment dispersion liquid including the pigment a dispersed in water was prepared. The pigment dispersion liquid was prepared by blending the pigment a, the pigment dispersion resin b, sodium hydroxide, SURFYNOL (registered trademark) 420, and water such that the content shown in Table 1 was achieved.

TABLE 1

| Component | Content (mass %) |
|---|---|
| Pigment a | 15 |
| Pigment dispersion resin b | 1.0 |
| Sodium hydroxide | 0~1.0 |
| SURFYNOL 420 | 0.5 |
| Water | Remainder |

Sodium hydroxide was blended as a neutralizer for neutralizing the pigment dispersion resin b. SURFYNOL (registered trademark) 420 is blended as a dispersant for enhancing the dispersibility of the pigment a in the solvent and is a non-ionic surfactant having an acetylene glycol structure manufactured by Nissin Chemical Co., Ltd. In all of Examples 1 to 3, Pigment Blue 15:3 (“LIONOL BLUE FG-7351” manufactured by Toyocolor Co., Ltd.) was used as the pigment a and ion exchanged water was used as water.

The pigment dispersion liquid was prepared by mixing the above components by wet dispersion using a media-type wet disperser. Examples of the media-type wet disperser include a wet disperser (more specifically, “Nano Grain Mill” manufactured by ASADA IRON WORKS. CO., LTD., “MSC mill” manufactured by NIPPON COKE & ENGINEERING. CO., LTD., “DYNO (registered trademark)-MILL” manufactured by Shinmaru Enterprises Corporation, and the like).

In the wet dispersion using a media-type wet disperser, media (zirconia beads having a diameter of 0.5 mm) were set in a vessel and the ejection rate was controlled to 200 to 600 g/min, thereby adjusting the average particle diameter of the pigment dispersion in which the dispersant has adhered to the pigment a dispersed in water to 90 to 110 nm. The particle size distribution of the pigment dispersion was measured using “Zetasizer Nano” manufactured by Sysmex Corporation with a diluted solution obtained by diluting the pigment dispersion liquid 300 times with ion exchanged water.

Next, inks according to Examples 1 to 3 were prepared. The inks according to Examples 1 to 3 were prepared by blending the above pigment dispersion liquid, SURFYNOL (registered trademark) 420, the water-soluble moisturizing agent c, and water such that the content shown in Table 2 was achieved.

TABLE 2

| Component | Content (mass %) |
|---|---|
| Pigment dispersion liquid | 53.3 |
| SURFYNOL 420 | 0.7 |
| Water-soluble moisturizing agent c | 30 |
| Water | Remainder |

In the preparation of the inks according to Examples 1 to 3, the components shown in Table 2 were added in order while stirring the solvent using a stirrer. Further, each ink after stirring was filtered using a filter having a pore size of φ5 μm to remove foreign substances, dirt, coarse particles, and the like.

### (Evaluation of Ink)

For the inks according to Examples 1 to 3, image density and diffusiveness of the pigment a were evaluated.

### Method of Evaluating Image Density

A solid image was formed on a recording medium (“CC90” manufactured by Mondi plc) using an inkjet recording apparatus (“TASKalfa Pro 15000c” manufactured by KYOCERA Document Solutions Inc.). Then, the image density of the dried solid image was measured using a spectrodensitometer (FD-5, manufactured by Konica Minolta, Inc.). For each ink, the average value of image densities obtained by the five measurements was used as an evaluation value for image density. Using the evaluation value for image density of each ink, evaluation was performed in accordance with the following criteria A and B. Inks with the evaluation of A for image density are evaluated to “Pass”, and inks with the evaluation of B are evaluated to “Fail”.
A (Good): 1.20 or more
B (Poor): less than 1.20.

### Method of Evaluating Diffusiveness of Pigment a

Images of 10 straight lines (1-dot lines) were formed on a recording medium (“CC90” manufactured by Mondi plc) using an inkjet recording apparatus (“TASKalfa Pro 15000c” manufactured by KYOCERA Document Solutions Inc.) with an ejection rate of 11 μL per dot. Then, the dried images of the straight lines were observed using an optical microscope (“MM-800” manufactured by Nikon Corporation), and the line width of the image of each straight line was measured by the application measurement “Line measurement”. For each ink, the average value of the line widths of the images of the 10 straight lines was used as an evaluation value for diffusiveness of the pigment a. Using the evaluation value for diffusiveness of the pigment a of each ink, evaluation was performed in accordance with the following criteria A and B. Inks with the evaluation of A for diffusiveness of the pigment a are evaluated to “Pass”, and inks with the evaluation of B are evaluated to “Fail”.
A (Good): 75 μm or more
B (Poor): less than 75 μm

### Example 1

In Example 1, ink samples 1 to 4 were prepared by the above method using pigment dispersion resins b1, b2, b3, and b4 formed of benzylmethacrylate (BzMMA)/methacrylic acid (MAA) copolymers (acid value: 100 mg KOH/g) having different configurations, and the above evaluation was performed on the samples 1 to 4. Table 3 shows the configuration of each of the pigment dispersion resins b1, b2, b3, and b4. The pigment dispersion resin b1 has the configuration of the pigment dispersion resin b according to this embodiment. Each of the pigment dispersion resins b2 and b3 has a block sequence different from that of the pigment dispersion resin b according to this embodiment. The pigment dispersion resin b4 is a random copolymer. Note that in all of the samples 1 to 4 according to Example 1, triethylene glycol monobutyl ether was used as the water-soluble moisturizing agent c.

TABLE 3

| | Pigment dispersion resin | | | |
|---|---|---|---|---|
| | b1 | b2 | b3 | b4 |
| Hydrophilic segment A | MAA | MAA | MAA | MAA |
| Hydrophobic segment B | BzMMA | BzMMA | BzMMA | BzMMA |
| Block sequence | X-Y-X | Y-X-Y | X-Y | Random |
| Acid value (mg KOH/g) | 100 | 100 | 100 | 100 |

Table 4 shows the pigment dispersion resins used for the sample 1 to 4 and the evaluation results of image density and diffusiveness of the pigment a for the samples 1 to 4. In the sample 1 in which the pigment dispersion resin b1 was used, both the image density and the diffusiveness of the pigment a were evaluated to “Pass”. On the other hand, in the samples 2 and 3 in which the pigment dispersion resins b2 and b3 having block sequences different from that according to this embodiment were used, both the image density and the diffusiveness of the pigment a were evaluated to “Fail”. Further, in the sample 4 in which the pigment dispersion resin b4 formed of a random copolymer was used, the image density was evaluated to “Fail” although the diffusiveness of the pigment a was evaluated to “Pass”.

TABLE 4

| | Pigment | Evaluation results | |
|---|---|---|---|
| No. | dispersion resin | Image density | Diffusiveness of pigments |
| 1 | b1 | A | A |
| 2 | b2 | B | B |
| 3 | b3 | B | B |
| 4 | b4 | B | A |

### Example 2

In Example 2, ink samples 5 to 9 were prepared by the above method using pigment dispersion resins b5, b6, b7, b8, and b9 formed of benzylmethacrylate (BzMMA)/methacrylic acid (MAA) copolymers having different acid values, and the above evaluation was performed on the samples 5 to 9. Table 5 shows the configuration of each of the pigment dispersion resins b5, b6, b7, b8, and b9. The acid value of the pigment dispersion resin b5 is less than 60 mg KOH/g. The acid values of the pigment dispersion resins b6, b7, and b8 are 60 mg KOH/g or more and 120 mg KOH/g or less. The acid value of the pigment dispersion resin b9 exceeds 120 mg KOH/g. Note that in all of the samples 5 to 9 according to Example 2, triethylene glycol monobutyl ether was used as the water-soluble moisturizing agent c.

TABLE 5

| | Pigment dispersion resin | | | | |
|---|---|---|---|---|---|
| | b5 | b6 | b7 | b8 | b9 |
| Hydrophilic | MAA | MAA | MAA | MAA | MAA |
| segment A | | | | | |
| Hydrophobic | BzMMA | BzMMA | BzMMA | BzMMA | BzMMA |
| segment B | | | | | |
| Block | X-Y-X | X-Y-X | X-Y-X | X-Y-X | X-Y-X |
| sequence | | | | | |
| Acid value | 50 | 60 | 95 | 120 | 130 |
| (mg KOH/g) | | | | | |

Table 6 shows the pigment dispersion resins used for the samples 5 to 9 and the evaluation results of image density and diffusiveness of the pigment a for the samples 5 to 9. In the samples 6 to 8 in which the pigment dispersion resins b6, b7, and b8 were used, both the image density and the diffusiveness of the pigment a were evaluated to “Pass”. On the other hand, in the sample 5 in which the pigment dispersion resin b5 having an acid value of less than 60 mg KOH/g was used, the diffusiveness of the pigment a was evaluated to “Fail” although the image density was evaluated to “Pass”. Further, in the sample 9 in which the pigment dispersion resin b9 having an acid value exceeding 120 mg KOH/g was used, the image density was evaluated to “Fail” although the diffusiveness of the pigment a was evaluated to “Pass”.

TABLE 6

| | Pigment | Evaluation results | |
|---|---|---|---|
| No. | dispersion resin | Image density | Diffusiveness of pigments |
| 5 | b5 | A | B |
| 6 | b6 | A | A |
| 7 | b7 | A | A |
| 8 | b8 | A | A |
| 9 | b9 | B | A |

### Example 3

In Example 3, ink samples 10 to 15 were prepared by the above method using different water-soluble moisturizing agents c1, c2, c3, c4, c5, and c6, and the above evaluation was performed on the samples 10 to 15. Table 7 shows the water-soluble moisturizing agents c1, c2, c3, c4, c5, and c6. The water-soluble moisturizing agents c1, c2, and c3 are each a glycol ether compound corresponding to the water-soluble moisturizing agent c according to this embodiment. On the other hand, the water-soluble moisturizing agent c4 is a glycol ether compound that does not correspond to the water-soluble moisturizing agent c according to this embodiment. Further, the water-soluble moisturizing agent c5 is a triol compound and the water-soluble moisturizing agent c6 is a diol compound. Note that in all of the samples 10 to 15 according to Example 3, a block copolymer that includes a hydrophilic polymer block X formed of methacrylic acid and a hydrophobic polymer block Y formed of benzylmethacrylate, and has a block sequence of X-Y-X and an acid value of 90 mg KOH/g was used as the pigment dispersion resin b.

TABLE 7

| | | Material name |
|---|---|---|
| Water-soluble | c1 | Triethylene glycol monobutyl ether |
| moisturizing agent | c2 | Triethylene glycol monoisopropyl ether |
| | c3 | Diethylene glycol monoisopropyl ether |
| | c4 | Triethylene glycol monoethyl ether |
| | c5 | Glycerin |
| | c6 | 3-methyl-1,5-pentanediol |

Table 8 shows the water-soluble moisturizing agents used for the samples 10 to 15 and the evaluation results of image density and diffusiveness of the pigment a for the samples 10 to 15. In the sample 10 to 12 in which the water-soluble moisturizing agents c1, c2, and c3 were used, both the image density and the diffusiveness of the pigment a were evaluated to “Pass”. On the other hand, in the sample 13 in which the water-soluble moisturizing agent c4 was used, the diffusiveness of the pigment a was evaluated to “Fail” although the image density was evaluated to “Pass”. Further, in the sample 14 in which the water-soluble moisturizing agent c5 was used, both the image density and the diffusiveness of the pigment a were evaluated to “Fail”. Further, in the sample 15 in which the water-soluble moisturizing agent c6 was used, the image density was evaluated to “Fail” although the diffusiveness of the pigment a was evaluated to “Pass”.

TABLE 8

| | Water-soluble | Evaluation results | |
|---|---|---|---|
| No. | moisturizing agent | Image density | Diffusiveness of pigments |
| 10 | c1 | A | A |
| 11 | c2 | A | A |
| 12 | c3 | A | A |
| 13 | c4 | A | B |
| 14 | c5 | B | B |
| 15 | c6 | B | A |

It should be understood by those skilled in the art that various modifications, combinations, sub-combinations and alterations may occur depending on design requirements and other factors insofar as they are within the scope of the appended claims or the equivalents thereof.

What is claimed is:

1. An inkjet ink, comprising:
a pigment;
a pigment dispersion resin formed of a block copolymer that includes a hydrophilic polymer block X formed of methacrylic acid and a hydrophobic polymer block Y formed of benzylmethacrylate and has a block sequence of X-Y-X and an acid value of 60 mg KOH/g or more and 120 mg KOH/g or less;
a water-soluble moisturizing agent that includes at least one of a polyhydric alcohol monoisopropyl ether or a polyhydric alcohol monobutyl ether; and
water.

2. The inkjet ink according to claim 1, further comprising
a non-ionic surfactant.
